(19) United States
(12) Patent Application Publication
(10) Pub. No.: US 2014/0092709 A1
(43) Pub. Date: Apr. 3, 2014

(54) PVDF SONAR TRANSDUCER SYSTEM

(71) Applicant: Garmin Switzerland GmbH, Schaffhausen (CH)

(72) Inventors: Albert F. Miller, Gardner, KS (US); John B. Whiteside, Lenexa, KS (US); Charles L. Hicks, Santa Cruz, CA (US)

(73) Assignee: Garmin Switzerland GmbH, Schaffhausen (CH)

(21) Appl. No.: 13/901,150

(22) Filed: May 23, 2013

Related U.S. Application Data
(60) Provisional application No. 61/651,619, filed on May 25, 2012.
(60) Provisional application No. 61/753,762, filed on Jan. 17, 2013.

(51) Int. Cl. G01S 15/02

(52) U.S. Cl. CPC G01S 15/02
USPC 367/87

(57) ABSTRACT

A sound navigation and ranging (SONAR) transducer system comprises a transmit element and a receive element. The transmit element may be formed from ceramic material and configured to transmit an ultrasonic signal into a body of water. The transmit element may include a first component configured to transmit the ultrasonic signal in a first direction and a second component configured to transmit the ultrasonic signal in a second direction. The receive element may be formed from polyvinylidene difluoride (PVDF) in the shape of a sheet of material and configured to receive a reflection of the ultrasonic signal after the ultrasonic signal is reflected from objects in the body of water. The receive element may include a first section configured to receive reflections from the first direction and a second section configured to receive reflections from the second direction.

### CROSS-REFERENCE TO RELATED APPLICATIONS

The present application claims the benefit of 35 U.S.C. §119(e) of U.S. Provisional Application Ser. No. 61/651,619, filed May 25, 2012, titled “SONAR TRANSDUCER SYSTEM,” and U.S. Provisional Application Ser. No. 61/753,762, filed Jan. 17, 2013, titled “SONAR TRANSDUCER SYSTEM.” Each of the above-identified applications is herein incorporated by reference in its entirety.

### BACKGROUND

Sound navigation and ranging (SONAR) is a method for using sound to detect objects on or under the surface of water. Active sonar systems transmit sound pulses into water and receive echoes returned from underwater features such as fish, objects, or the bottom of the body of water. The received echoes may be processed to display the detected underwater features (e.g., the location of fish or sunken objects) and to determine the depth of the body of water. SONAR systems are often mounted on the hull of a marine vessel to scan for features around the vessel. Side scan SONAR systems typically insonify underwater areas in the port and starboard directions of the marine vessel, while down scan systems insonify underwater areas beneath the marine vessel. Some SONAR systems include both down scan and side scan elements to insonify various areas surrounding the marine vessel.

### SUMMARY

Embodiments of the present technology provide sound navigation and ranging (SONAR) transducer system comprising a transmit element, a receive element, and a housing. The transmit element may be formed from ceramic material and configured to transmit an ultrasonic signal into a body of water. The transmit element may include a first component configured to transmit the ultrasonic signal in a first direction and a second component configured to transmit the ultrasonic signal in a second direction. The receive element may be formed from polyvinylidene difluoride (PVDF) in the shape of a sheet of material and configured to receive a reflection of the ultrasonic signal after the ultrasonic signal is reflected from objects in the body of water. The receive element may include a first section configured to receive reflections from the first direction and a second section configured to receive reflections from the second direction. The housing retains the transmit element and the receive element and may attach to an exterior surface of a hull of a marine vessel below the waterline.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology is described in detail below with reference to the attached drawing figures, wherein:

FIG. 1 is a front view of a sound navigation and ranging (SONAR) transducer system constructed in accordance with various embodiments of the present technology;

FIG. 2 is a side view of the SONAR transducer system;

FIG. 3 is a perspective view of a rectangular bar shaped transmit element of the SONAR transducer system;

FIG. 4 is a perspective view of a cylindrical shaped transmit element of the SONAR transducer system;

FIG. 5 is a perspective view of a receive element of the SONAR transducer system;

FIG. 6 is an end view of a plurality of components of the transmit element with a plurality of sections of the receive element in a first configuration;

FIG. 7 is a perspective view of the transmit element and the receive element of FIG. 6;

FIG. 8 is an end view of components of the transmit element with sections of the receive element in a second configuration;

FIG. 9 is a perspective view of the transmit element and the receive element of FIG. 8;

FIG. 10 is an end view of components of the transmit element with sections of the receive element in a third configuration;

FIG. 11 is a perspective view of the transmit element and the receive element of FIG. 10;

FIG. 12 is an end view of components of the transmit element with sections of the receive element in a fourth configuration; and

FIG. 13 is a perspective view of the transmit element and the receive element of FIG. 12.

FIG. 14 is an end view of components of another configuration of the present technology.

FIG. 15 is a perspective view of components of another configuration of the present technology.

FIG. 16 is a top view diagram illustrating exemplary transmit and receive patterns for one exemplary configuration of the present technology.

FIG. 17 is a top view diagram illustrating exemplary transmit and receive patterns for another exemplary configuration of the present technology.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Embodiments of the present technology relate to a sound navigation and ranging (SONAR) transducer system for use with a marine vessel. The SONAR transducer system generally transmits an ultrasonic signal into a body of water and receives reflections of the ultrasonic signal to detect objects in the water surrounding the marine vessel as well as determine the range or distance to the sides and bottom of the body of water. The reflections of the ultrasonic signal may also be utilized to display images of the body of water to the sides of and beneath the marine vessel.

Conventional sonar systems often use piezoelectric ceramic puck elements to transmit cone-shaped ultrasonic beams into the water. In contrast, side scan and down scan systems often rely on the use of a piezoelectric ceramic bar element to transmit one or more fan-shaped ultrasonic beams into the water.

Embodiments of the present technology provide a sonar transducer system that eliminates the need to transmit fan-shaped ultrasonic beams into the water for side scan and down scan purposes. Instead, one or more piezoelectric ceramic puck elements may be used to transmit one or more cone-shaped ultrasonic beams into the water. A PVDF piezoelectric receiver, with a fan-shaped receive pattern, may be used to receive echoes of the transmitted beams for sonar processing. This allows a piezoelectric ceramic puck element to be used to generate side scan and down scan sonar images. In some configurations, the system may additionally or alternatively include conventional piezoelectric bar elements to transmit fan-shaped ultrasonic beams that are received by the PVDF receiver. Embodiments of the present technology provide a SONAR transducer system with a transmit element and a receive element. The transmit element may be formed from ceramic material, and the receive element may be formed from a thin sheet of polymer, such as polyvinylidene difluoride (PVDF). Given that PVDF is smaller in size and volume than conventional sonar elements, the SONAR transducer package may be smaller, or lower profile, with more options of configurations.

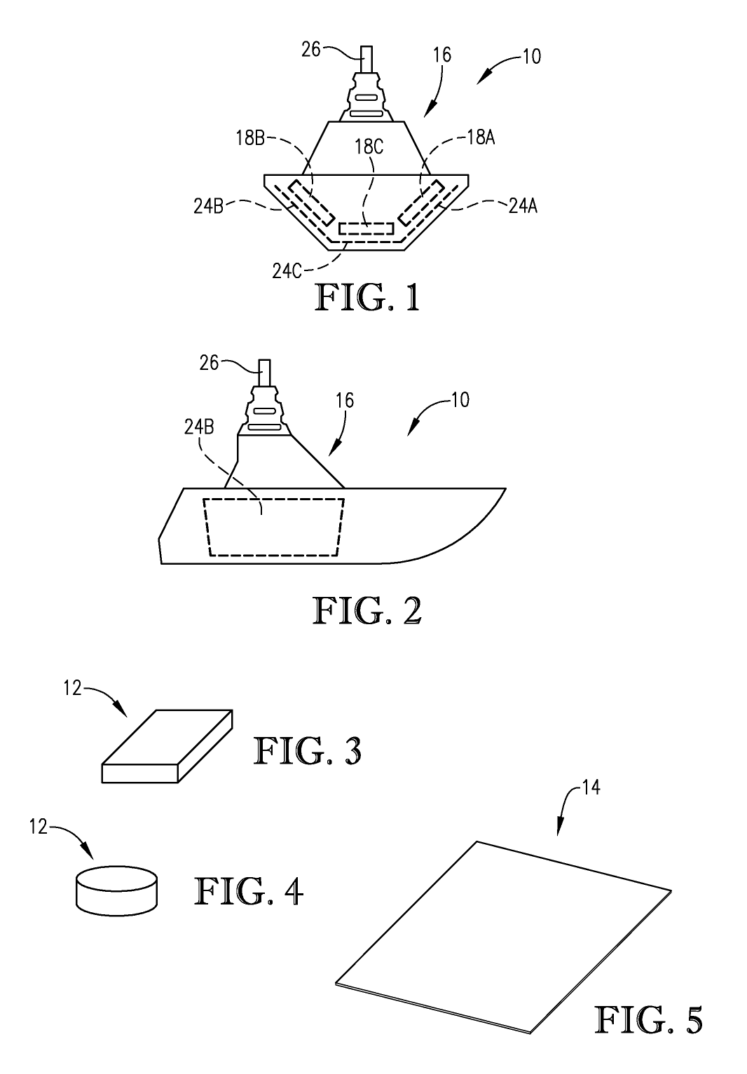

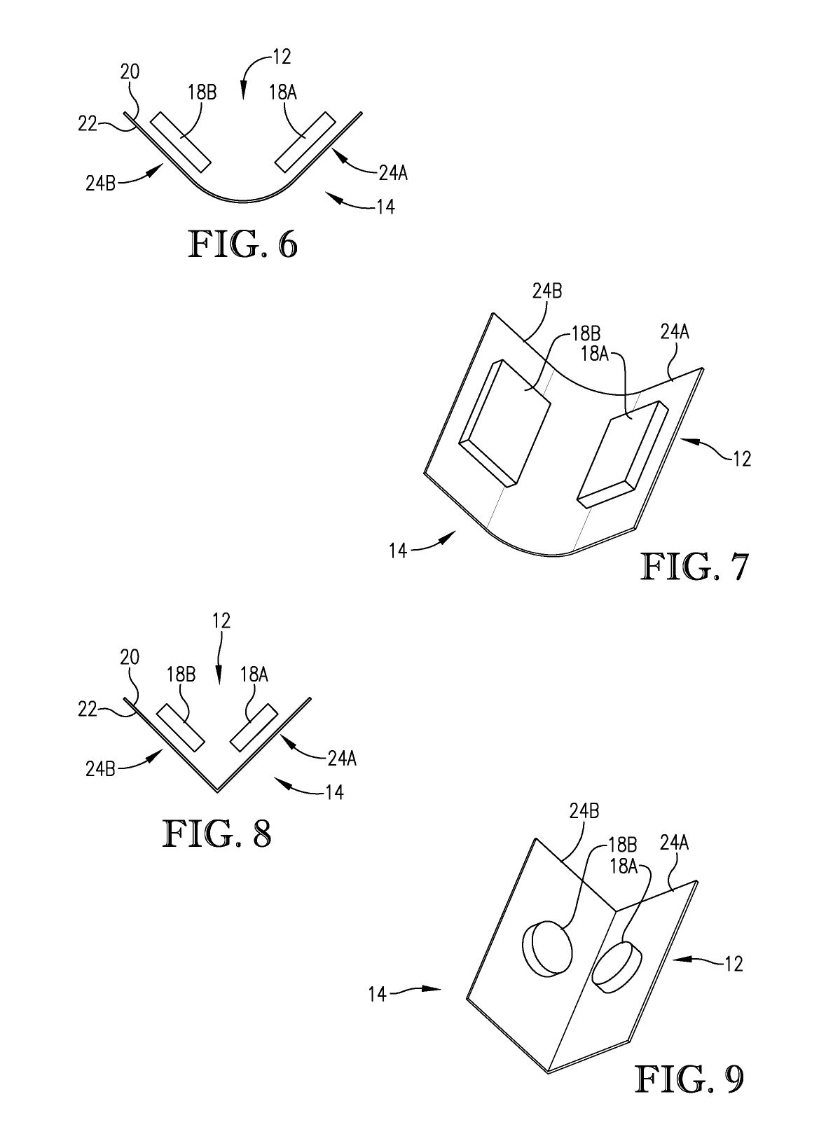

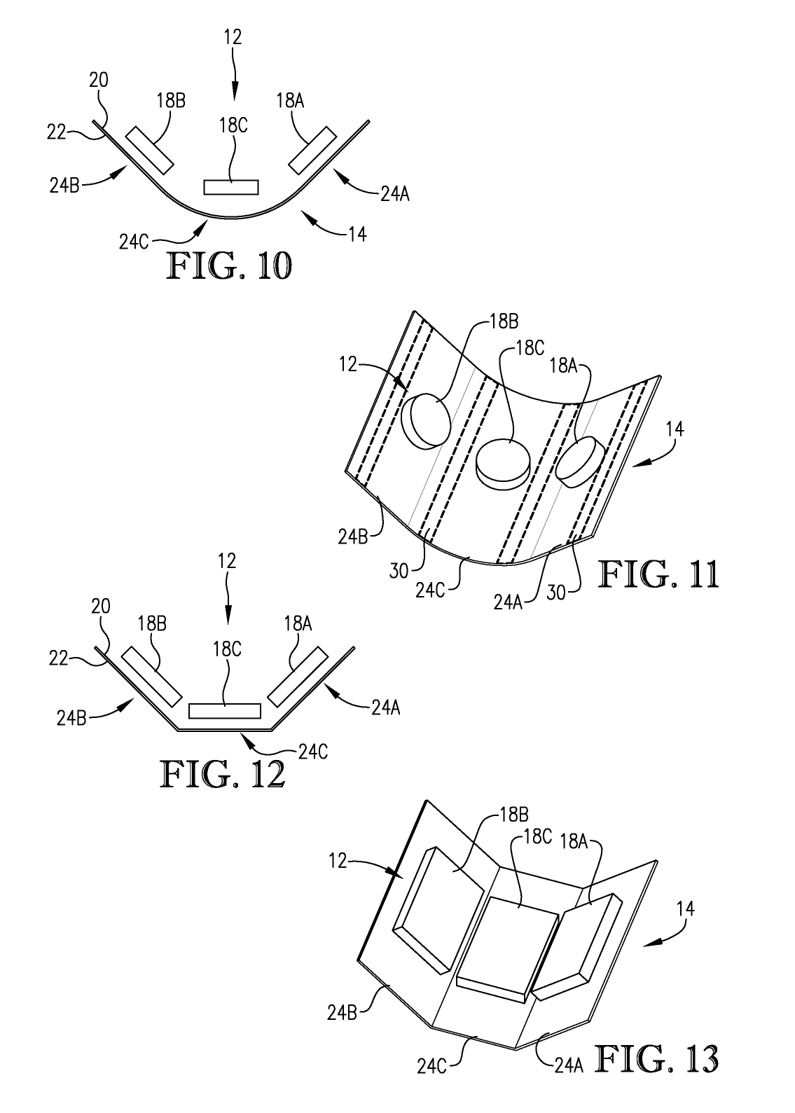

Embodiments of the technology will now be described in more detail with reference to the drawing figures. Referring initially to FIGS. 1 and 2, a sound navigation and ranging (SONAR) transducer system 10 is illustrated which broadly comprises a transmit element 12, a receive element 14, and a housing 16.

The transmit element 12, as seen in FIGS. 1, 3, 4, and 6-13, generally transmits an ultrasonic signal into the body of water. The transmit element 12 may be formed from ceramic materials that exhibit piezoelectric transducing properties, such as barium titanate, lead titanate, lead zirconate titanate, lithium niobate, lithium tantalate, bismuth ferrite, sodium niobate, and the like, or combinations thereof. The transmit element 12 may vibrate in response to a periodic or oscillating transmit electrical signal applied to it. The transmit electrical signal may be applied by amplifier circuits, electronic oscillator circuits, multivibrator circuits, signal generators, and the like, or combinations thereof. The vibrations of the transmit element 12 produce the ultrasonic signal. The frequency of the ultrasonic signal may range from approximately 50 kiloHertz (kHz) to approximately 1000 kHz, although wider ranges are possible.

In some embodiments, the transmit element 12 may be formed in a rectangular bar shape, typically with a greater length dimension than width and height dimensions, as shown in FIGS. 1, 3, 6, 7, 12, and 13. Thus, the transmit element 12 may have two primary faces on opposing sides with the greatest surface area, as compared with the other faces. For the rectangular shaped transmit element 12, the primary faces may have an elongated rectangular shape.

In one configuration, the transmit element 12 may present rectangular dimensions of approximately 40-100 mm in length, 2-3 mm in width, and 3-5 mm in thickness to generate a conventional fan-shaped ultrasonic signal. In another configuration the transmit element 12 may present rectangular dimensions of approximately 10-30 mm in length, 2-3 mm in width, and 3-5 mm in thickness. This “short” configuration generates a hybrid, semi-ovular, signal that includes elements of both conventional and fan-shaped sonar signals. The semi-ovular shaped signal generated by the “short” transmit element 12 is useful for generating both conventional fish “arch” signatures and high-resolution down and side scan images.

In other embodiments, the transmit element 12 may have a roughly cylindrical shape, typically with a diameter dimension that is greater than its length, as seen in FIGS. 4 and 8-11. The cylindrical shaped transmit element 12 may have circular shaped primary faces. Still other embodiments of the transmit element 12 may include oval, elliptical, or similar shaped primary faces.

The pattern of the ultrasonic signal generated by the transmit element 12 depends largely on the shape of the primary faces of the transmit element 12. For example, the rectangular shaped transmit element 12 may generate an ultrasonic signal with a fan shape, wherein the aspect ratio of the base of the fan shape corresponds to the aspect ratio of one of the primary faces of the transmit element 12. In addition, the cylindrical shaped transmit element 12 may generate an ultrasonic signal with a roughly conical shape.

The ultrasonic signal generated by the transmit element 12 may be directional in nature. Typically, the ultrasonic signal is generated in a direction that is normal to the surface of one of the primary faces of the transmit element 12. In some embodiments, the transmit element 12 may include a single element, as seen in FIGS. 3 and 4, that generates the ultrasonic signal. The single transmit element 12 may be positioned or oriented to transmit the ultrasonic signal in a desired direction in the body of water.

In order to scan a greater volume of the body of water, other embodiments of the transmit element 12 may include a plurality of components 18, as shown in FIGS. 1 and 6-13, each of which is operable to transmit the ultrasonic signal. The components 18 may all have the same shape or may include a combination of shapes. In a first exemplary embodiment shown in FIGS. 6 and 7, the transmit element 12 may include first and second components 18A, 18B each with a rectangular bar shape. The components 18A, 18B may be positioned with their longitudinal axes oriented in the same direction. In a second exemplary embodiment shown in FIGS. 8 and 9, the components 18A, 18B each have a cylindrical shape. Furthermore, the components 18A, 18B may be positioned such that an angle formed between the primary faces of the first component 18A and the primary faces of the second component 18B ranges from approximately 90 degrees to approximately 150 degrees. In a third exemplary embodiment shown in FIGS. 10 and 11, the transmit element 12 may include a third component 18C with a cylindrical shape positioned between the first and second components 18A, 18B. In a third exemplary embodiment shown in FIGS. 1, 12, and 13, the third component 18C may have a rectangular bar shape. Likewise with the first exemplary embodiment, the components 18A, 18B, 18C may be positioned with their longitudinal axes oriented in the same direction. In addition, a first angle formed between the primary faces of the first and third components 18A, 18C and a second angle formed between the primary faces of the second and third components 18B, 18C may range from approximately 120 degrees to approximately 150 degrees.

The receive element 14, as shown in FIGS. 1, 2, and 5-13, generally receives a reflection of the ultrasonic signal after the ultrasonic signal is reflected from objects in the body of water (such as fish, underwater objects, and terrain features such as the bottom of the body of water). The receive element 14 is generally formed from polymer material, specifically from polyvinylidene difluoride (PVDF). The PVDF of the receive element 14 is a piezoelectric transducing material which may generate a receive electrical signal in response to receiving mechanical vibrations from the reflections of the ultrasonic signal. The receive electrical signal may be electrically communicated to amplifier circuits, filter circuits, digital signal processors (DSPs), and the like, or combinations thereof. Ultimately, the receive electrical signal is converted to a video image which may be shown on a video display of a marine vessel equipment, such as a SONAR display, chartplotter, and/or a fishfinder.

The receive element 14 may be formed in a sheet of material with a thickness that is generally much less than its length and width dimensions. In exemplary embodiments, the receive element 14 may have a thickness of approximately 0.5 millimeters. The receive element 14 may include an upper surface 20 and an opposing lower surface 22, as best seen in FIGS. 6, 8, 10, and 12. The surfaces 20, 22 typically have a rectangular area, although other shapes, such as a square, diamond, or ellipse, are possible. However, the receive element 14 may have any thickness and may comprise more than one layer of PVDF material.

Due to the relative thinness of PVDF, and the ease in which it can be cut, shaped, and folded, the receive element 14 utilized by embodiments of the present invention may be easily adapted for use with side scan, down scan, and other sonar scan configurations. The PVDF material may be cut, shaped, bent, and formed into non-rectangular shapes to enhance sonar performance and minimize side lobe sensitivity.

In some configurations, such as where the system 10 is configured for down scan, the system 10 may include a single transmit element 12 and a single receive element 14 comprising a single sheet of PVDF material. In other configurations, such as side scan configurations, the receive element 14 may include one or more sections 24 that are configured to receive the reflection of the ultrasonic signal. In some embodiments, the sections 24 may be planar. In other embodiments, the sections 24 may include a roundness or a curvature. Typically, the receive element 14 includes at least one section 24 for each component 18 of the transmit element 12. The sections 24 may be positioned or oriented with an angle formed therebetween in order for the receive element 14 to receive reflections from different directions. In a first exemplary embodiment shown in FIGS. 6-9, the receive element 14 may include first and second sections 24A, 24B that are positioned with an angle between them that ranges from approximately 90 degrees to approximately 150 degrees. In a second exemplary embodiment shown in FIGS. 10-13, the receive element 14 may include a third section 24C positioned between the first and second sections 24A, 24B. A first angle between the first and third sections 24A, 24C and a second angle between the second and third sections 24B, 24C may range from approximately 120 degrees to approximately 150 degrees. The PVDF material of the receive element 14 is generally flexible and, in some embodiments, may be manipulated to form the various sections 24 from a single sheet of material. In other embodiments, each section 24 of the receive element 14 may be formed from a separate sheet of PVDF material. In some configurations, such as the example of FIG. 11, breaks 30 are formed in the PVDF material to electrically separate the various sections 24A, 24B, 24C of the receive element 14.

The shape of the receive element 14 can be selected to minimize sidelobe levels. The shape may be elliptical, binomial, a sinc function, or another shape which adjusts the weight given to signals along the length of the element 14. The receive element 14 may be composed of an array of elements, such as an array of polymer sheets. Further, as discussed above, the receive element 14 may be curved or U-shaped to facilitate side scanning through the use of a unitary polymer sheet. Similarly, the receive element 14 may be spherical or shaped as a torus to facilitate surround scanning.

The transmit element 12 and the receive element 14 may be positioned as shown in the exemplary embodiments of FIGS. 6-13, wherein the components 18 of the transmit element 12 are positioned adjacent to and overlapping the upper surface 20 of the sections 24 of the receive element 14. In alternative embodiments not shown in the figures, the transmit element 12 may be positioned in proximity to, but not overlapping, the receive element 14.

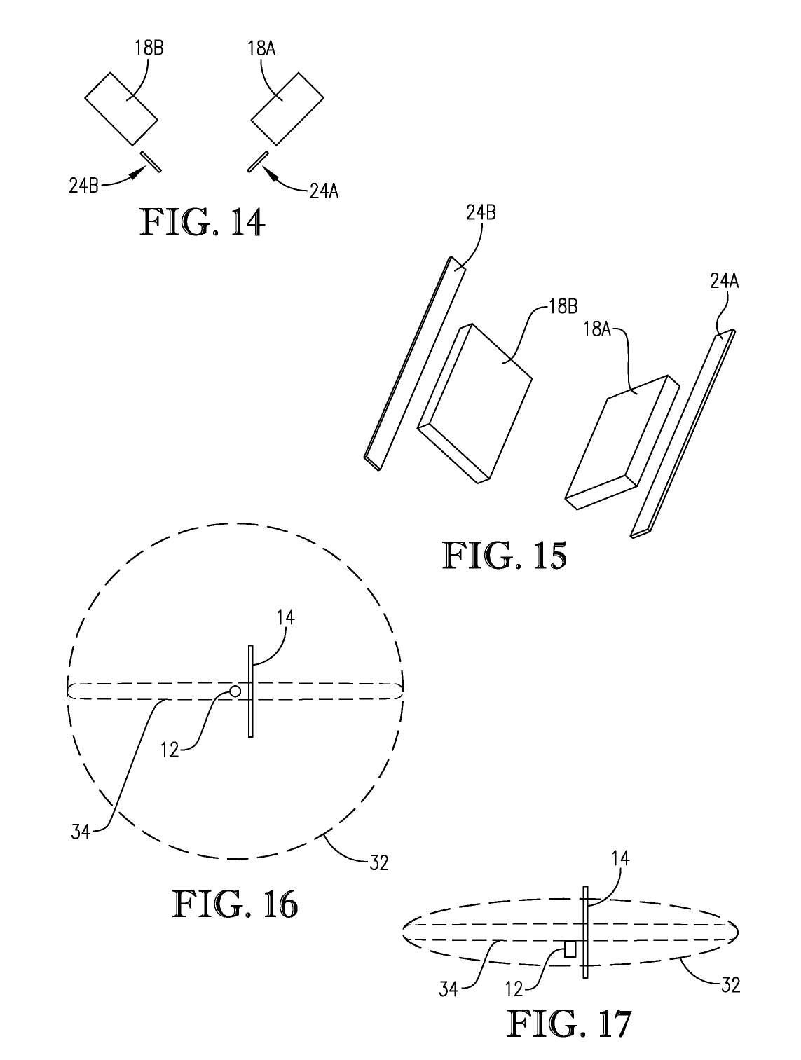

In some configurations, like those illustrated in FIGS. 14-15, the transmit element 12 and receive element 14 may be positioned side-by-side each other in a non-overlapping configuration. Thus, for example, components 18A, 18B of the transmit element 12 may be positioned along side of sections 24A, 24B of the receive element 14.

The housing 16, as shown in FIGS. 1 and 2, generally retains the transmit element 12 and the receive element 14 and may be formed of any suitable materials, including a variety of polymers, such as polypropylene, or other materials that are waterproof. The housing 16 may couple with a cable 26 that communicates the transmit electrical signal and the receive electrical signal to external electrical equipment. The housing 16 may encase both the transmit element 12 and the receive element 14 in addition to other associated components such as electrodes, wires, or other conductive elements required connect the cable 26 to the transmit element 12 and the receive element 14. In some configurations, the housing 16 may include a first portion for housing the transmit element 12 and a second portion for housing the receive element 14. The first and second portions of the housing 16 may be physically separate and attached to different positions on the hull of the marine vessel.

The housing 16 may be configured to attach to an exterior surface of a hull of the marine vessel below the waterline. Typically, the housing 16 is attached to the marine vessel at the transom of the hull (e.g., transom-mount). In some embodiments, the housing 16 may be attached on one side or the other of the centerline. In other embodiments, the housing 16 may be attached to the marine vessel along its centerline. In other configurations, the housing 16 may be adapted to attach to a trolling motor associated with the marine vessel, as a through-hole installation, and/or be configured as a stand-alone housing operable to be positioned in the water independent of the hull of marine vessel (e.g., via towing from the marine vessel, by direct operator placement, etc.). In some configurations, the housing 16 may be placed inside of the hull of marine vessel to transmit and receive signals through the hull (i.e., an in-hull installation).

The system 10 may function as follows. The system 10 may be connected to a piece of marine vessel equipment, such as a SONAR display, chartplotter, and/or a fishfinder. The equipment may include a signal generator configured to generate an oscillating transmit electrical signal with a frequency ranging from approximately 50 kHz to approximately 1000 kHz. The equipment may further include a signal processor and a display. The signal generator may communicate the transmit electrical signal to the transmit element 12, which in turn may vibrate in response, thereby generating the ultrasonic signal. The transmit electrical signal may comprise a series pulses of a single frequency in the range mentioned above. Alternatively, each pulse may include a plurality of frequencies wherein the frequency is swept either increasingly or decreasingly from one value to another value. Accordingly, the ultrasonic signal may include a series of acoustic pulses of a single frequency or a swept frequency.

For a rectangular shaped transmit element 12, the pattern of the ultrasonic signal may be fan shaped. For a cylindrical shaped transmit element 12, the ultrasonic signal pattern may have a conical shape. Furthermore, the transmit element 12 may include a plurality of components 18, as shown in FIGS. 1 and 6-13, to generate ultrasonic signals in different directions of the body of water. In some embodiments, the transmit element 12 may include the first component 18A positioned to generate a first ultrasonic signal in the body of water to the left side of the marine vessel and the second component 18B positioned to generate a second ultrasonic signal in the body of water to the right side of the marine vessel. In other embodiments, the transmit element 12 may include the third component 18C, positioned between the first and second components 18A, 18B, which generates a third ultrasonic signal in the downward direction beneath the marine vessel.

The ultrasonic signals travel through the water, reflecting off of objects therein, such as fish or other water animals, debris, features on the bottom of the body of water, and the like. The reflections of the ultrasonic signals are received by the receive element 14, which may include a plurality of sections 24 as seen in FIGS. 1 and 6-13, each positioned to receive reflections from a different direction. In some embodiments, the receive element 14 may include the first section 24A positioned to receive reflections from the body of water to the left side of the marine vessel and the second section 24B positioned to receive reflections from the body of water to the right side of the marine vessel. In other embodiments, the receive element 14 may include the third section 24C, positioned between the first and second sections 24A, 24B, which receives reflections from the body of water beneath the marine vessel.

As the reflections impact the PVDF material of the receive element 14, they are converted a receive electrical signal which includes characteristics of the objects from which the ultrasonic signal is reflected. In various embodiments, each section 24 of the receive element 14 may produce a separate receive electrical signal. The receive electrical signal may be communicated from the receive element 14 to the signal processor of the marine vessel equipment. An image may be formed from the reflected ultrasonic signal that is shown on the display. In various embodiments, a separate image may be displayed for each section 24 of the receive element 14.

In embodiments, the receive element 14 is configured with a fan-shaped receive pattern, such as where the receive element 14 (and/or sections thereof) presents a rectangular shape. The receive pattern of the receive element 14 may be modified by altering the shape of the receive element 14. In contrast to conventional ceramic transducers, PVDF sheets like the receive element 14 may be cut and formed into any number of arbitrary shapes to produce any number of arbitrary receive patterns. For example, the receive element 14 may be configured as an irregular polygon to provide a fan-shaped receive pattern with minimized side lobes. Similarly, the PVDF receive element 14 may be cut, bent, and shaped into any form to accommodate conventional, down, and side scan SONAR functionality. Such shaping abilities also enable the housing 16 to present unique and accommodating dimensions. Thus, use of PVDF for the receive element 14 provides the system 10 with the flexibility to employ any receive pattern—regardless of the transmit pattern employed by the transmit element 12.

For example, the transmit element 12 may be configured with a cylindrical transducer element for generating a conical ultrasonic signal while the receive element 14 may be configured with a fan-shaped receive pattern. Such a configuration enables the system 10 to provide high-resolution down and side scan functionality regardless of the shape and configuration of the transmit element 12. In some embodiments, the transmit element 12 may also be adapted as a receive element to transmit and receive signals. For example, in the above example, the cylindrical transducer element may transmit and receive with a conical pattern to provide conventional SONAR functionality. The addition of the receive element 14, with its fan-shaped receive pattern, enables the system to simultaneously provide conventional SONAR and down scan / side scan functionality. Other combinations, including any number of conventional transmit elements and PVDF receive elements, are possible to provide any combination and coverage of conventional, down scan, and side scan SONAR functionality. Thus, the PVDF receive element 14, with its fan-shaped receive pattern and minimal thickness, may be easily added to conventional SONAR configurations to provide down and/or side scan functionality.

Exemplary transmit and receive patterns, as viewed from above the marine vessel looking into the water, for the transmit element 12 and receive element 14 are illustrated in FIGS. 16-17. In the example of FIG. 16, the generally cylindrical transmit element 12 generates a transmit pattern 32 with a generally conical shape (i.e., with a circular cross section). The receive element 14 of FIG. 16 is configured with a receive pattern 34 presenting a fan shape. In configurations, the receive pattern 34 may be configured to present at least a 10 to 1 (length to width) ratio to provide desired SONAR performance. In other configurations, the receive pattern 34 may be configured to present at least a 20 to 1 ratio. Additionally, in some embodiments, the transmit element 12 of FIG. 16 may also function as a receiver (with a conical-shaped receive pattern) to enable conventional SONAR functionality independent of the receive element 14.

In the example of FIG. 17, the “short” bar transmit element 12 generates the transmit pattern 32 with a semi-ovular shaped pattern. In some configurations, the length-to-width of the semi-ovular pattern is no more than 10 to 1. In other configurations, the length-to-width of the semi-ovular pattern is no more than 8 to 1. This configuration of the transmit element 12, and the resulting semi-ovular transmit pattern, enables the hybrid functionality described above. For example, the transmit element 12 of FIG. 17 may also function as a receiver (with a semi-ovular shaped receive pattern) to enable hybrid SONAR functionality independent of the receive element 14. The receive element 14 of FIG. 17 is configured with the receive pattern 34 presenting a fan shape as described above with respect to FIG. 16.

In some configurations, the system 10 may be configured for compressed high-intensity radar pulse (CHIRP) functionality. CHIRP enhances SONAR performance by transmitting a pulsed signal that sweeps from low to high frequencies instead of the conventional use of a single-frequency signal. CHIRP signals received by the receive element 14 may be separated into their respective frequencies and analyzed and weighted to provide additional resolution beyond that available through single-frequency SONAR systems. In embodiments, the transmit element 12 may configured to generate a CHIRP pulse and the receive element 14 and associated electronics may be configured to receive and process the CHIRP pulse. That is, the utilization of PVDF as the receive element 14 does not prevent the utilization of CHIRP technology.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

What is claimed is:

1. A sound navigation and ranging (SONAR) transducer system comprising:
a transmit element formed from ceramic material and configured to transmit an ultrasonic signal into a body of water; and
a receive element formed from polyvinylidene difluoride (PVDF) in the shape of a sheet of material and configured with a fan-shaped receive pattern to receive a reflection of the ultrasonic signal after the ultrasonic signal is reflected from objects in the body of water.

2. The system of claim 1, wherein the receive element is positioned between the transmit element and the body of water.

3. The system of claim 1, wherein the receive element has a thickness of approximately 0.5 millimeters.

4. The system of claim 1, wherein the receive element has a rectangular shaped surface area.

5. The system of claim 1, wherein the receive element includes connected first and second planar sections, each section including an upper surface, and the transmit element includes first and second components with the first component positioned adjacent to the upper surface of the first section and the second component positioned adjacent to the upper surface of the second section.

6. The system of claim 5, wherein the first and second components are each rectangular bar shaped to produce a fan-shaped ultrasonic signal.

7. The system of claim 5, wherein the first and second components are each substantially cylindrical in shape to produce at least one cone-shaped ultrasonic signal.

8. The system of claim 5, wherein the receive element further includes a third section coupled to the first and second sections and positioned therebetween, the third section including an upper surface, wherein the transmit element includes a third component positioned adjacent to the upper surface of the third section.

9. The system of claim 8, wherein the third section is arcuate.

10. The system of claim 8, wherein the third section is planar.

11. A sound navigation and ranging (SONAR) transducer system comprising:
a transmit element formed from ceramic material and configured to transmit an ultrasonic signal into a body of water, the transmit element including a first component configured to transmit the ultrasonic signal in a first direction and a second component configured to transmit the ultrasonic signal in a second direction; and
a receive element formed from polyvinylidene difluoride (PVDF) in the shape of a sheet of material and configured with a fan-shaped receive pattern to receive a reflection of the ultrasonic signal after the ultrasonic signal is reflected from objects in the body of water, the receive element including a first section configured to receive reflections from the first direction and a second section configured to receive reflections from the second direction.

12. The system of claim 11, wherein the first and second components are each rectangular bar shaped to produce a fan-shaped ultrasonic signal.

13. The system of claim 11, wherein the first and second components are each substantially cylindrical in shape to produce at least one cone-shaped ultrasonic signal.

14. The system of claim 11, wherein each section includes an upper surface, and the first component is positioned adjacent to the upper surface of the first section and the second component is positioned adjacent to the upper surface of the second section.

15. The system of claim 14, wherein the receive element further includes a third section coupled to the first and second sections and positioned therebetween, the third section including an upper surface, wherein the transmit element includes a third component positioned adjacent to the upper surface of the third section.

16. The system of claim 11, wherein the receive element has a rectangular shaped surface area and a thickness of approximately 0.5 millimeters.

17. A sound navigation and ranging (SONAR) transducer system comprising:
a transmit element formed from ceramic material and configured to transmit an ultrasonic signal into a body of water, the transmit element including a first component configured to transmit the ultrasonic signal in a first direction and a second component configured to transmit the ultrasonic signal in a second direction; and
a receive element formed from polyvinylidene difluoride (PVDF) in the shape of a sheet of material and configured with a fan-shaped receive pattern to receive a reflection of the ultrasonic signal after the ultrasonic signal is reflected from objects in the body of water, the receive element including a first section configured to receive reflections from the first direction and a second section configured to receive reflections from the second direction, each section including an upper surface,
wherein the first component is positioned adjacent to the upper surface of the first section and the second component is positioned adjacent to the upper surface of the second section.

18. The system of claim 17, wherein the first and second components are each rectangular bar shaped to produce a fan-shaped ultrasonic signal.

19. The system of claim 17, wherein the first and second components are each substantially cylindrical in shape to produce at least one cone-shaped ultrasonic signal.

20. The system of claim 17, wherein the receive element further includes a third section coupled to the first and second sections and positioned therebetween, the third section including an upper surface, wherein the transmit element includes a third component positioned adjacent to the upper surface of the third section.
